(19) United States
(12) Patent Application Publication
(10) Pub. No.: US 2007/0016771 A1
(43) Pub. Date: Jan. 18, 2007

(54) Maintaining security for file copy operations

(75) Inventors: Gary G. Allison, Austin, TX (US); John Eric Eaton, Houston, TX (US); Mark Radulovich, Houston, TX (US)

Correspondence Address: WONG, CABELLO, LUTSCH, RUTHERFORD & BRUCCULERI LLP, 20333 SH 249, SUITE 600, HOUSTON, TX, 77070, US

(73) Assignee: SimDesk Technologies, Inc., Houston, TX (US)

(21) Appl. No.: 11/228,151

(22) Filed: Sep. 16, 2005

Related U.S. Application Data
(60) Provisional application No. 60/698,161, filed on Jul. 11, 2005.

(51) Int. Cl. H04L 9/00

(52) U.S. Cl. 713/165

(57) ABSTRACT

Securing computer files in which a publish permission is present in a file system. Upon receiving a request to write data from one file to another, the file system determines whether publish permission is needed. If so and the user lacks the publish permission, the request is rejected. Disclosed is securing computer files which include encrypting metadata about an encrypted file and storing both the encrypted file and the encrypted metadata. The metadata includes a key for decrypting the encrypted file. The key for decrypting the metadata is stored in a USB security token. Disclosed is securing computer files which include copying material from a window displaying the contents of a file to a clipboard application. The file or window is associated with the material. The clipboard application can deny a request to paste material associated with one file to a window displaying the contents of a different file.

### CROSS REFERENCE TO RELATED APPLICATIONS

This application claims the benefit under 35 U.S.C. § 119(e) of U.S. Provisional Patent Application Ser. No. 60/698,161, entitled “Maintaining Security for file Copy Operations with Secure Clipboard Function and with Secure Local Storage of Files” by Gary Allison, Mark Radulovich and Eric Eaton, filed July 11, 2005, which is hereby incorporated by reference. This application is also related to U.S. Patent Application Nos. ______, entitled “Secure Local Storage of Files” and ______, entitled “Secure Clipboard Function”, to the same inventors as this application and filed concurrently herewith, both of which are hereby incorporated by reference.

### BACKGROUND OF THE INVENTION

1. Field of the Invention

The field of the invention is data processing, and, more specifically, methods, systems, and products for securing computer files.

2. Description Of Related Art

Securing computer files is critical for businesses and other endeavors. Data contained in computer files can represent the intellectual capital of a business and form a significant portion of its value. Losing the data is a loss of capital and can seriously harm the business. In addition, a business may have a legal or contractual duty to preserve the confidentiality of data stored in computer form, such as medical records, credit card numbers, and social security numbers. Allowing unauthorized persons to access the data would violate the duty and might expose the business to liability.

Often the data is stored in a file format, with the files contained in folders. Folders, and even files, can have security rights provided to them to prevent unauthorized access. However, once accessible, files can be freely moved to other folders, including folders without security rights. Confidentiality could be breached simply by transferring a file to an insecure folder, thus breaching the entire security structure.

One attempt to provide a more secure file system is Mandatory Access Control or MAC. In a MAC environment, files are classified with labels, which are effectively clearance or rights levels, such as extremely secret, top secret, secret and so on, and users are similarly granted similar labels. A user with a given label can access all files having an equal or lower label. That user may also write to folders having equal or lower labels. However, a file with a given label cannot be stored into a folder having a lower label.

While MAC does improve file security, it only operates within its levels. A user with the proper label can transfer a file to any other folder with equal labels. MAC thus provides only one dimension of security. Conventional access permissions can be combined with MAC to provide a more robust file system. This will produce a security environment that is extremely difficult to manage in a shared user environment, thus providing an increased opportunity for security breaches.

Further, files are conventionally loaded into application programs, such as Microsoft Word. One feature of current application programs is the ability to cut or copy material using a clipboard feature. However, this provides a possible security breach avenue. Confidential information could simply be placed in the clipboard when opened securely, as with Word, and then pasted into an insecure location, such as another Word document or the like. While disabling clipboard functionality can address this security concern, it also removes a desirable feature.

Cryptography may be used to safeguard files stored in computer memory. Cryptography is the process of encryption, or transforming information into a form which is not understandable; and decryption, restoring the information to an understandable form. Often cryptography uses a secret piece of information, called a key, to perform the encryption and decryption. Typically, the key is an input to a mathematical algorithm that performs the transformations. The algorithm may be symmetric or asymmetric. Symmetric algorithms use the same key for encryption and decryption. Asymmetric algorithms use a pair of keys, often a public key and a private key obtained from a public key/private key infrastructure.

One problem with cryptography, however, is safely storing the key used for decryption. If the key is stored on the computer, then the encrypted data is vulnerable to an unauthorized user's locating the key and accessing the data. If the key is built into a program, then the encrypted data is vulnerable to an unauthorized user's gaining entry to the program. Further, while cryptographic techniques can be used to secure files, both during storage and during transmission, the files must be decrypted for local operation. Should the file then be stored locally, they could be stored in a decrypted form, thus again providing a mechanism for a security breach.

It would be desirable to improve computer data file systems to prevent these potential security breaches.

### SUMMARY OF THE INVENTION

Methods, systems, and products are disclosed in which securing computer files are provided generally by receiving in a file system in which the file permissions include publish permission a request from a user process to write data from a file in a source folder to a file in a destination folder; determining that publish permission is required to write the data to the file in the destination folder; determining that the user has or lacks publish permission; and allowing or denying the request to write the data to the file in the destination folder; where the holders of certain permissions in the file in the source folder differ from the holders of certain permissions in the file in the destination folder.

Methods, systems, and products are disclosed in which securing computer files are provided generally by encrypting a file; encrypting metadata about the file, including a key for decrypting the file; storing the encrypted file and the encrypted metadata; and storing the key for decrypting the metadata in a USB security token.

Methods, systems, and products are disclosed in which securing computer files are provided generally by receiving in a clipboard application a request to copy material selected from a window associated with a file; copying the material to a private clipboard application; and limiting the potential to output the clipped materials to only selected locations, such as the original window.

Methods, systems, and products are disclosed for securing computer files in which a publish permission is one of the permissions of a file system. Upon receiving a request from a user process to write data from one file to another, the file system may determine whether publish permission is needed to write the data. If publish permission is necessary to write the data and the user process lacks the publish permission, the file system may reject the request to write the data.

Methods, systems, and products are disclosed for securing computer files which include encrypting metadata about an encrypted file and storing both the encrypted file and the encrypted metadata. The metadata includes a key for decrypting the encrypted file. The key for decrypting the metadata is stored in a USB security token.

Methods, systems, and products are disclosed for securing computer files which include copying material from a window displaying the contents of a file to a clipboard application. The file or window is associated with the material. The clipboard application can deny a request to paste material associated with one file or window to a window displaying the contents of a different file.

### BRIEF DESCRIPTION OF THE DRAWINGS

FIG. 1 sets forth a network diagram illustrating an exemplary system for securing computer files according to embodiments of the present invention.

FIG. 2 sets forth a block diagram of automated computing machinery comprising an exemplary computer useful in securing computer files according to embodiments of the present invention.

FIGS. 3 and 4 set forth charts illustrating exemplary file operations for users without and with publish permission authority.

FIG. 5 sets forth a flowchart illustrating an exemplary method for securing computer files according to embodiments of the present invention that includes performing file system operations in a file system with the publish permission attribute for files.

FIG. 6 sets forth exemplary data structures useful for securing computer files according to embodiments of the present invention.

FIG. 7 sets forth a flowchart illustrating the downloading and uploading of a file according to embodiments of the present invention.

FIG. 8 sets forth a flowchart illustrating an exemplary method for storing the key for decrypting a file.

FIG. 9 sets forth a flowchart illustrating the use of a clipboard according to embodiments of the present invention.

### DETAILED DESCRIPTION OF EXEMPLARY EMBODIMENTS

### Introduction

The present invention is described to a large extent in this specification in terms of methods for securing computer files. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### DETAILED DESCRIPTION

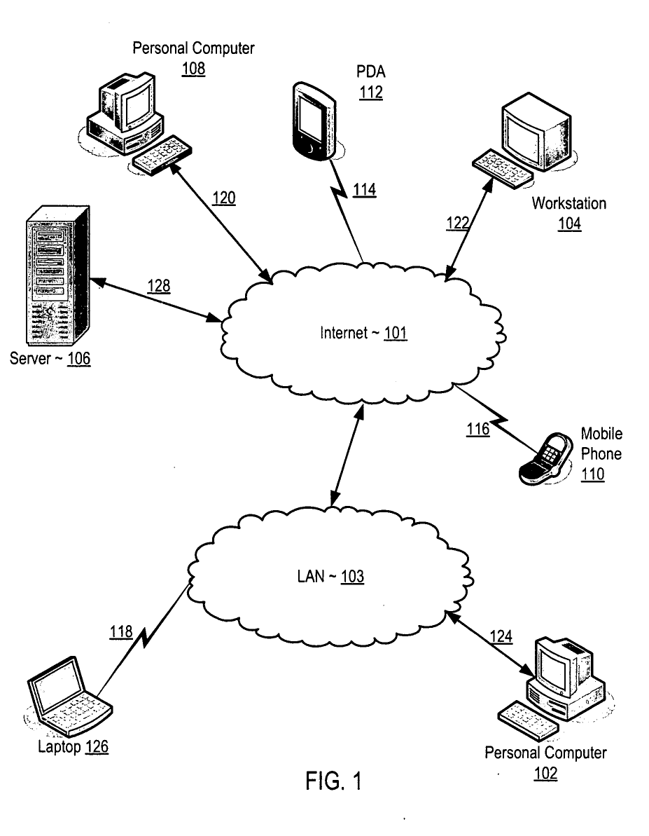

Exemplary methods, systems and products for securing computer files according to embodiments of the present invention are described with reference to the accompanying drawings, beginning with FIG. 1. FIG. 1 sets forth a network diagram illustrating an exemplary system for securing computer files according to embodiments of the present invention. The term ‘network’ is used in this specification to mean any networked coupling for data communications among two or more computers. Network data communication typically is implemented with specialized computers called routers and switches. Networks typically implement data communications by encapsulating computer data in messages that are then routed from one computer to another. A well known example of a network is the Internet, a world-wide interconnected system of computers that communicate with one another according to the ‘Internet Protocol’ as described in the IETF's RFC 791. Other examples of networks useful with various embodiments of the present invention include intranets, extranets, local area networks (‘LANs’), wide area networks (“WANs”), and other network arrangements as will occur to those of skill in the art. Typically, a LAN is a network connecting computers and word processors and other electronic office equipment to create a communication system between offices.

The system of FIG. 1 includes various devices communicatively coupled through two networks, the Internet (101) and LAN (103). The system of FIG. 1 includes a server (106), a computer coupled to the Internet (101) through wireline connection (128), which operates as a file system server and an application server. Devices communicate with server (106) to run applications and access files. The system of FIG. 1 includes several devices communicatively coupled to the Internet (101) and capable of requesting access to files or applications provided by server (106), including:
mobile phone (110), coupled to the Internet (101) through wireless connection (116)
workstation (104), a computer coupled to the Internet (161) through wireline connection (122),
personal digital assistant (112), coupled to the Internet (101) through wireless connection (114), and
personal computer (108), coupled to the Internet (101) through wireline connection (120).

The system of FIG. 1 also includes several devices communicatively coupled to LAN (103) and capable of requesting access to files or applications provided by server (106) by communicating indirectly with server (106). These devices include:
personal computer (102), coupled to LAN (103) through wireline connection (124), and
laptop computer (126), coupled to LAN (103) through wireless connection (118).

The LAN (103) provides direct data communications between laptop (126) and personal computer (102). The two networks, the LAN (103) and the Internet (101), also provide indirect data communications between devices coupled to the LAN (103) and devices coupled to the Internet (101). Data from a device communicatively coupled to the Internet (101) is transferred over the Internet (101) to the LAN (103), and from there to a device connected to the LAN (103), and vice versa. A device such as a router (not shown) interconnects the Internet (101) and the LAN (103).

The arrangement of a server, two networks, and various devices requesting services from the server in FIG. 1 are for explanation, not for limitation. Data processing systems useful for securing computer files according to various embodiments of the present invention may include fewer or additional servers, routers, other devices, and peer-to-peer architectures, not shown in FIG. 1, as will occur to those of skill in the art. Any networks in such data processing systems may support many data communications protocols, including for example TCP/IP, HTTP, WAP, HDTP, and others as will occur to those of skill in the art. Networks are not necessary for securing computer files according to various embodiments of the present invention. Data processing systems useful for securing computer files according to various embodiments of the present invention may consist of a single stand-alone computer not connected to a network. Various embodiments of the present invention may be implemented on a variety of hardware platforms and network configurations in addition to those illustrated in FIG. 1. All such embodiments are well within the scope of the present invention.

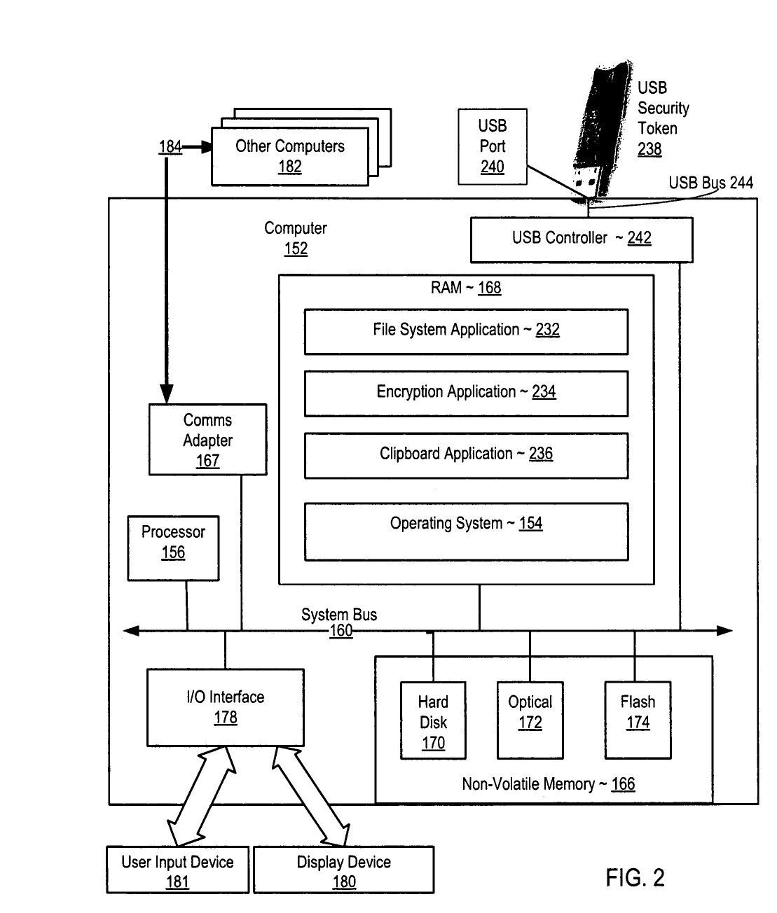

Securing computer files in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in securing computer files according to embodiments of the present invention. In the illustrated embodiment, the computer (152) is most exemplary of a personal computer (102 or 108) of FIG. 1. A server (106) will have a slightly different configuration. The computer (152) of FIG. 2 includes at least one processor (156) or ‘CPU’ as well as random access memory (168) (‘RAM’) which is connected through a system bus (160) to the processor (156) and to other components of the computer. The computer (152) of FIG. 2 also includes a universal serial bus (‘USB’) (244), a type of connection between external peripheral devices (‘USB devices’) and the computer (152) using a simple four wire cable. The USB devices plug into the computer (152) at a USB port (240). The USB port (240) is connected through the USB bus (244) to a USB controller (242), hardware which communicates over a USB bus with USB devices and controls the transfer of data from a computer to USB devices and vice versa. The USB controller (242) is connected through the system bus (160) to the processor (156) and to RAM (168).

The exemplary computer (152) of FIG. 2 also includes a removable USB security token (238) connected to computer (152) through the USB port (240). A USB security token is a USB device which contains a ‘smart chip’, a mini-version of a microprocessor and memory, and plugs into a USB port. The memory of the USB security token may contain a digital certificate which is used to identify a user. In an embodiment of the invention, the USB security token is an eToken manufactured by Aladdin Knowledge Systems, Inc. 2920 N. Arlington Heights Road Arlington Heights, Ill. 60004.

Stored in RAM (168) is file system application (232), which is computer program instructions for maintaining a file system and for processing requests to read from and write to the files in the file system. Also stored in RAM (168) is an encryption application (234), which is computer program instructions for encrypting and decrypting files. The encryption application (234) may use public and private keys from a public/private key infrastructure or may use symmetric keys or may use any decryption and encryption methods as will occur to those of skill in the art, and all such methods also fall well within the scope of the present invention. Also stored in RAM (168) is a clipboard application (236), a set of computer program instructions that provide for the temporary storage of data selected from the currently active window by a user, and for the retrieval of the data. The application processes commands to store selected data from the active window (‘copy’ or ‘cut’) and to retrieve stored data and place it in the currently active window (‘paste’).

Also stored in RAM (168) is an operating system (154). Operating systems useful in computers according to embodiments of the present invention include UNIX™, Linux™, Microsoft Windows™, AIX™, IBM's i5/OS™, and others as will occur to those of skill in the art. The operating system (154), file system application (232), encryption application (234), and clipboard application (236) in the example of FIG. 2 are shown in RAM (168), but many components of such software typically are stored in non-volatile memory (166) also. An encryption application (234) may also be stored in the USB security token (238).

The computer (152) of FIG. 2 includes non-volatile computer memory (166) coupled through the system bus (160) to the processor (156) and to other components of the computer (152). The Non-volatile computer memory (166) may be implemented as a hard disk drive (170), an optical disk drive (172), an electrically erasable programmable read-only memory space (so-called ‘EEPROM’ or ‘Flash’ memory) (174), RAM drives (not shown), a combination of the above or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters include modems for wired dial-up communications, Ethernet (IEEE 802.3) adapters for wired network communications, and 802.11b adapters for wireless network communications.

A server will often have a similar structure to that of the computer (152) of FIG. 2 but certain additional aspects may be included. For example, because the server 106 is accessible through the Internet (101), it will include various Internet interface software, such as web hosting software to interact with a web browser application on another computer. This web hosting and web browsing software usually contains their own encryption components to provide secure information transfer over the Internet (101). For example, a file provided by the server (106) to the personal computer (102) would be encrypted prior to transmission and would be decrypted upon receipt, thus allowing the personal computer (102) to use the server (106) as a means for file storage. One advantage of such file storage is ease of access from multiple locations and by multiple parties.

With the capability for access by multiple users, security issues beyond just those related to transmission over the network develop. As discussed in the background, there are then security issues as to transfer of files by users. A file may contain confidential information so that its dissemination is limited. Thus some method of file security must be imposed on server-stored files. Conventionally this is done by limiting access to folders containing the files based on user characteristics. But problems still occur as described above.

To address these problems, embodiments according to the present invention limit transfer of files between folders. Users are placed into groups. Folders, and thus files within those folders, are classified as secure or privileged. Groups, and individual users, are assigned rights with respect to the folder and its files. These rights include conventional rights such as read, delete and modify, but also a new right termed “publish”. If a folder is marked secure, only users, either individually or based on group affiliation, with publish rights are allowed to transfer a file from a secure folder to a non-secure folder. A non-secure folder can be a folder with no security or a folder where a different group of users has security rights. Users without publish rights may only transfer files within secure folders, in this case those with secure and identical user groups.

Files from the server (106) can also be copied to a local personal computer (102). If the files are from a secure folder on the server (106), security must be maintained in this operation. A user with publish rights will be allowed to copy the file to any location on the personal computer (102) but a user without publish rights will only be allowed to copy the file to secure personal folders on the local personal computer (102). In the preferred embodiment this secure folder is encrypted using a USB token as described below.

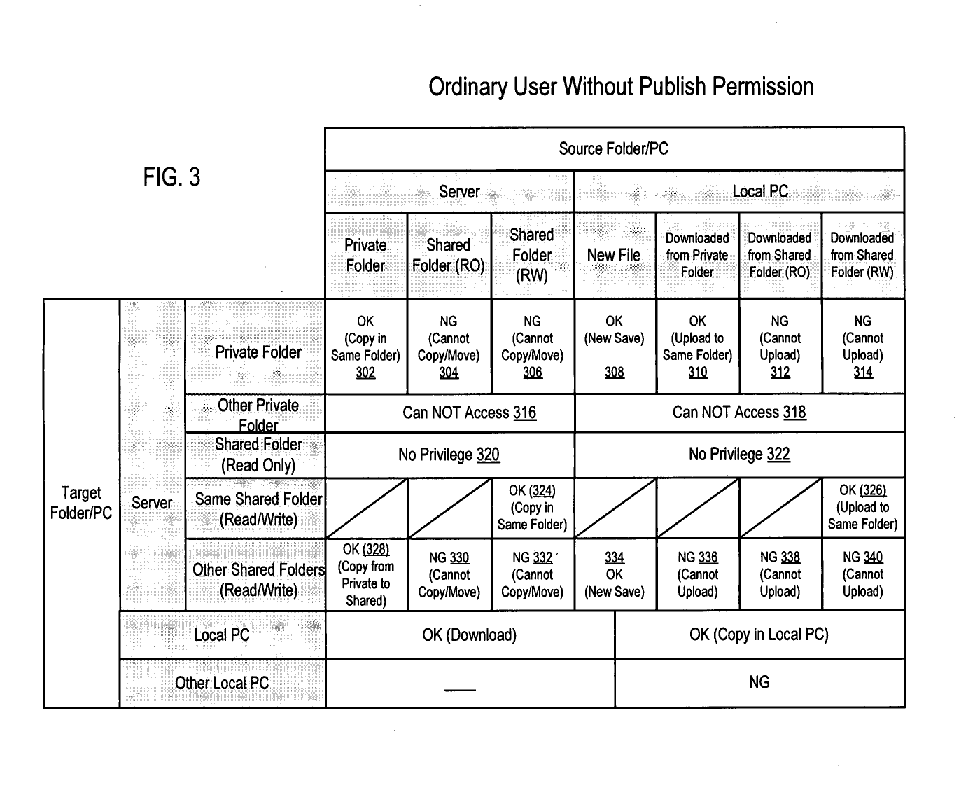

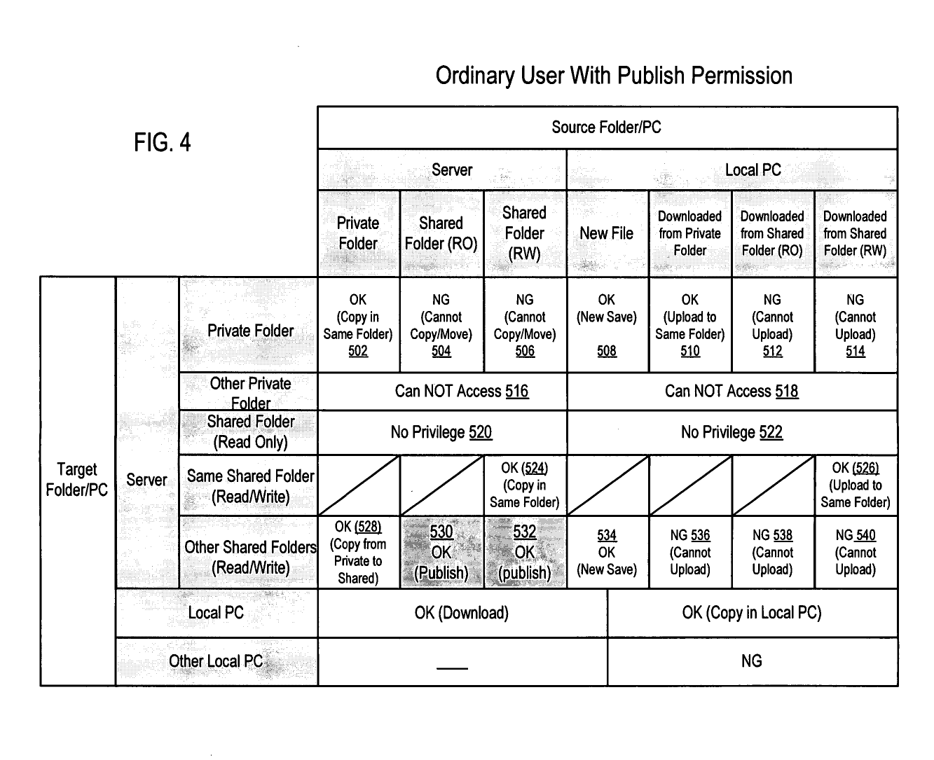

This has been a summary description. FIGS. 3 and 4 are exemplary charts setting forth the results of file transfer operations for users without (FIG. 3) and with (FIG. 4) publish rights or privileges. In the exemplary charts of FIGS. 3 and 4, the source for a file is indicated by the entries in the shaded areas at the top of the diagram and the target of a file is shown by the entries in the shaded areas to the left of the diagram. An entry in a numbered cell contained in a column and row indicates the result of attempting to transfer or copy a file from the source indicated at the top of the column to the target indicated at the left of the row. Element (332) of FIG. 3, for example, indicates the result of attempting to transfer a file from a shared folder in which the user has read/write (“RW”) permission to a different shared folder in which the user has also has read/write permission. As indicated by element (332), the user without publish permission may not transfer or copy the file from one shared folder to another shared folder.

The row in FIG. 3 with elements from (302) to (314) sets forth the results of an attempt to move data to a private folder on the server. In the example of FIG. 3, a private folder is a folder accessible only by a single ordinary user rather than a group. The user may transfer data from the private folder to any target for which the user has write permission. In the example of FIG. 3, only data that is not secure may be transferred to the private folder on the server. That includes a transfer of other data on the private folder (302), a newly-created file (308), and data previously downloaded from the private folder on the server (310). Secure data may not be transferred (“NG”) to the private folder on the server. The secure data includes data from group folders on the server (304 and 306) and data downloaded from group folders on the server (312 and 314), regardless of whether the user has read permission only (“RO”) or read/write permission.

The following row of FIG. 3 containing elements (316) and (318) sets forth the results of attempting to transfer data to the private folder of another user. In the example of FIG. 3, an ordinary user does not have permission to access the private folder of another user. Thus, access to the private folder of the other user is denied (316 and 318). The following row of FIG. 3 indicates that a user with read only permission for a folder may not write to the folder (320 and 322).

The following row sets forth the results of a transfer of data from one file within a group folder to another file within the group folder by a user with read/write permission on the folder. The user may transfer the data whether the transfer occurs within the server (324) or whether the transfer constitutes the download of a file from the folder and then an upload of the file to the folder (326). The diagonal line in the other cells in the row indicates that the transfer to the target described on the left, to the same shared folder with read/write permission, cannot occur from the source indicated above. The only source of such a transfer is a shared folder with read/write permission.

The row with elements (328) through (340) indicates the results of attempting to transfer data to a secure shared or group folder from a different folder. Without publish permission, a user may not transfer secure data to a different group folder, whether from a shared folder on the server (330 and 332) or from a local PC (336, 338 and 340). In the example of FIG. 3, the user without publish permission may transfer to the secure folder only data that is not secure. The non-secure data includes data contained in the user's private folder (328) and data in a new file (334).

The second-last row indicates the results of attempting to transfer a file to the local PC. In the example of FIG. 3, there is no restriction on the placement of files within folders on a local PC. The local PC in FIG. 3 may, for instance, be a single-user computer. In the example of FIG. 3, a user has permission to download to the local PC any file the user can access on the server. The user also has permission to copy any file on the local PC to another location. The last row of FIG. 3 indicates that a transfer of a file directly from one local PC to another is prohibited. A user with access to both local PCs may, however, be able to transfer a file indirectly from one PC to the other by uploading the file from one PC to the server and downloading it from the server to the other PC.

FIG. 4 is an exemplary chart setting forth the results of file transfer operations for users with (FIG. 4) publish rights or privilege. In general, the results of the file operations of FIG. 4 are the same as those for FIG. 3 and for the same reasons. The only difference between the charts occurs with elements (530) and (532), indicated by shading. In FIG. 4, a user with permission to write and publish to a folder may transfer a file to the folder from another shared folder for which the user has read permission, whether the user has write permission (532) or only read permission (530) in the other shared folder. In FIG. 3, where the user lacks publish permission, the user is unable to transfer a file to the folder from another shared folder.

The exemplary charts of FIGS. 3 and 4 are for explanation, not for limitation. In an alternative embodiment of the invention, the files on a local PC may be organized into individual and group folders, and the results of transferring files from one folder of the local PC to another may have results similar to the transfer of files from one folder to another on the server. In an alternative embodiment of the invention, a user may require publish permission to transfer a file from the user's private folder to a group folder. In such a case, a user may be permitted to transfer any file for which the user has read permission to the user's private folder. Methods of organizing files and folders and of determining the results of file operations may be carried out as will occur to those of skill in the art, and all such alternative embodiments are well within the scope of the present invention.

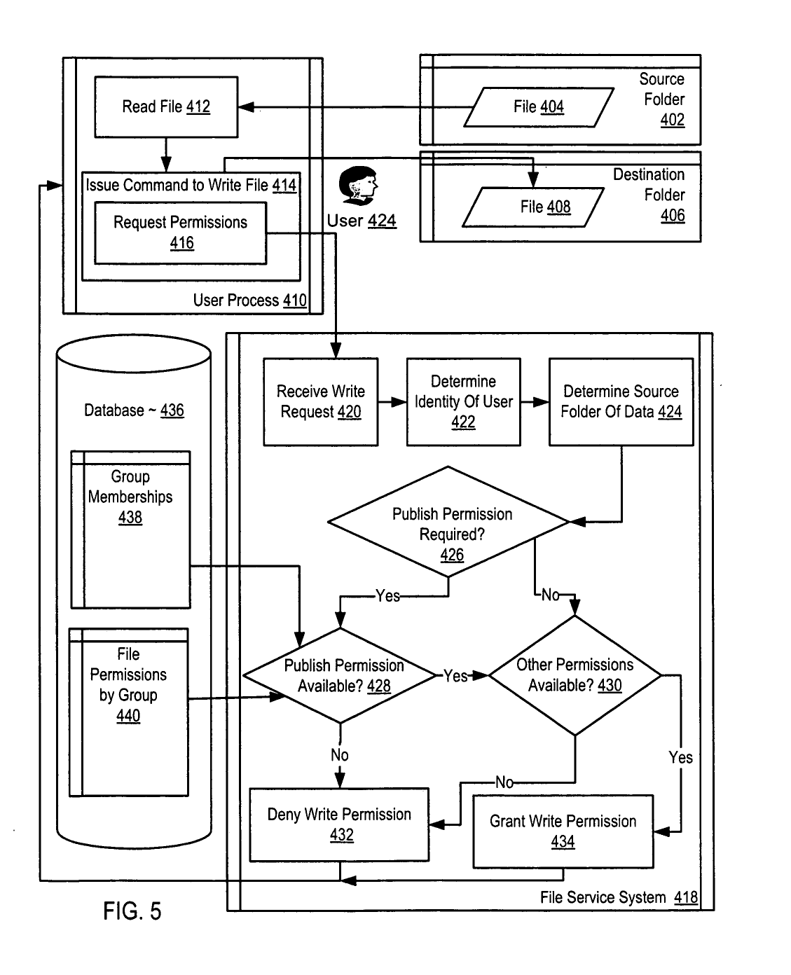

For further explanation, FIG. 5 sets forth a flow chart illustrating an exemplary method for securing computer files according to embodiments of the present invention that includes performing file system operations in a file system with the security properties described above, including publish permission attribute for files. As described above, publish permission is the right to write data from a file accessible by one set of users to another file accessible by a different set of users.

In the method of FIG. 5, a file service system (418), present on the server and the personal computer, administers a file system with the publish permission attribute. The file service system (418) processes requests to read and write files. The functions of the file service system (418) include checking the permissions of the processes that attempt to access files. In the method of FIG. 5, a user process (410), created by a user (424), reads (412) a file (404), which is stored in source folder (402). The user process (410) may read (412) the file (404) by copying the contents of the file (404) into a temporary storage buffer in RAM. The method of FIG. 5 also includes the user process (410) issuing (414) a command to write the contents of the file (404) to a file (408) in a destination folder (406). Issuing (414) the write command includes requesting (416) permissions from the file service system (418).

In the method of FIG. 5, the file service system (418) receives (420) the write request. The file service system (418) determines (422) the identity of the user (424). The file service system (418) may determine (422) the identity of the user (424) by checking the user identity of the process (410) that sends the request. In the method of FIG. 5, the file service system (418) also determines (424) the source folder of the data for which the write request was received. In case a write request refers to the contents of a buffer, the file service system (418) may determine (424) the source folder of the contents of the data by determining the file and folder associated with the buffer.

The method of FIG. 5 also includes the file service system (418) determining (426) whether publish permission is required to write the data to the file (408) in the destination folder (406). File systems with the publish permission attribute may adopt a variety of policies on the circumstances in which publish permission is or is not needed, as described above and shown on FIGS. 3 and 4. Publish permission may not be needed to write data from a source folder to a destination in the same directory, from a source folder owned by a group to a destination folder owned by the same group, from a group folder accessible by a user to an individual folder accessible only by the user, or to any destination folder from a file accessible by the general public. On the other hand, publish permission may be needed to move data from a folder owned by one group to a folder owned by another group. Other policies for determining when publish permission is needed to move data from a file in a source folder to a file in a destination folder will occur to those of skill in the art, and all such rules are well within the scope of the present invention.

If publish permission is required, in the method of FIG. 5, the file service system (418) determines (428) if the user process (410) possesses publish permission. In the method of FIG. 5, the file service system (418) determines (428) if the user process (410) possesses publish permission by examining a database (436) of group memberships (438) and file permissions (440) by group. The file service system (418) queries the database (436) to determine the group to which owner of the user process (410) belongs. The file service system (418) also queries the database (436) to determine the file permissions available to the group. The use of a data base to record publish permissions, the organization of the records in the database, and the assigning of publish permission by group are for explanation and not for limitation. Other architectures for determining if publish permission is available may occur to those of skill in the art, and all such architectures are well within the scope of the present invention.

The method of FIG. 5 further includes denying (432) the user process (410) permission to write the file (408) to the destination folder (406) when publish permission is required and the user process (410) does not have publish permission. If the user process (410) does have publish permission, the method of FIG. 5 further includes checking (430) if other permissions needed to write the file (408) to the destination folder (406) are available. If so, the file service system (418) grants to the user process (410) permission to write the file (408). If other permissions needed to write the file (408) to the destination folder (406) are not available, the file service system (418) denies (432) to the user process (410) permission to write the file (408).

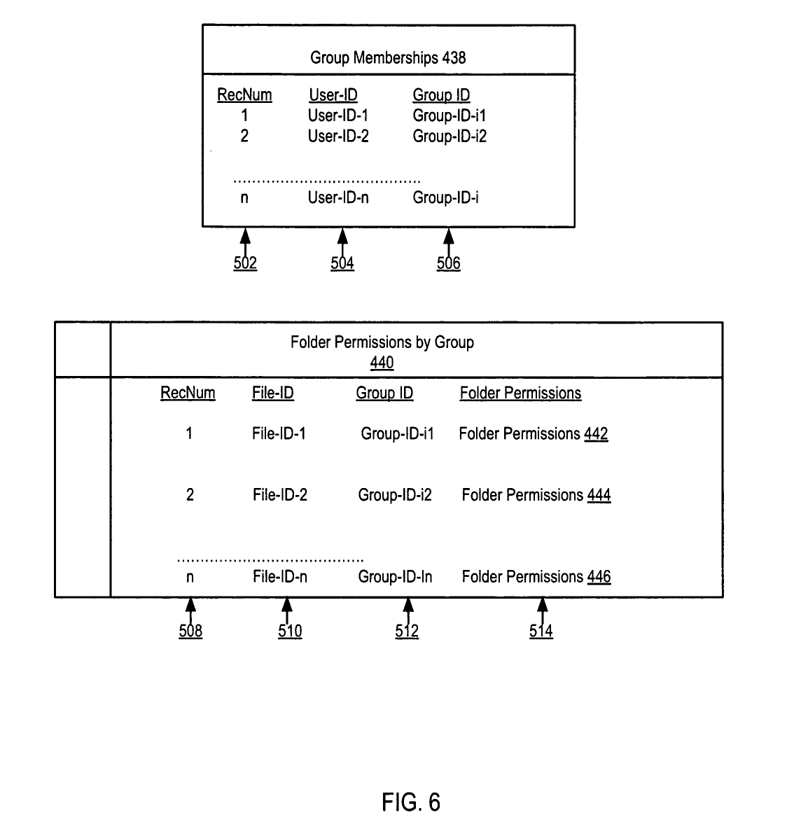

For further explanation, FIG. 6 sets forth a drawing of exemplary data structures useful for securing computer files according to embodiments of the present invention. The exemplary data structures of FIG. 6 include a record structure to represent group memberships (438) of a file system user. Each record in the group memberships record structure includes a record number field (502), which identifies the record; a user-id field (504) which identifies a user of the file system, and a group-id field (506) which identifies a group to which the user belongs. The exemplary data structures of FIG. 6 also include a record structure to represent folder permissions by group (440) in a file system with the publish permission attribute. Each record in the folder permissions record structure includes a record number field (508), which identifies the record; a folder-id field (510), which identifies a folder of the file system; a group id field (512), which identifies a group; and a folder permissions field (514) which indicates the folder permissions belonging to the group. The field may consist of a binary number whose digits correspond to the various types of permissions. For example, in a file system with read, write, and publish permissions a three-digit binary number may represent the respective permissions, with a 0 indicating that the group does not have the permission and with a 1 representing that the group does have the permission. In this representation, the number 110 represents possessing read and write but not publish permissions. Alternatively the folder permission field (514) may be in the form of a string with “r” representing read permission, “w” representing write permission, and “p” representing publish permission. Combinations of letters may represent combinations of permissions. For example, the combination “rw” may represent read and write but not publish permission. Records such as these illustrated in FIG. 6 may be used by the file service system (418) in FIG. 5 to determine if a user has permission to publish a file in a folder in a folder belonging to a group.

The exemplary records of FIG. 6 are for explanation, not for limitation. In an alternative embodiment of the invention, the records may represent permissions by file, rather than by folder. Records describing the permissions of users in files and folders may be in such formats and may contain such data as will occur to those of skill in the art, and all such alternative embodiments are well within the scope of the present invention.

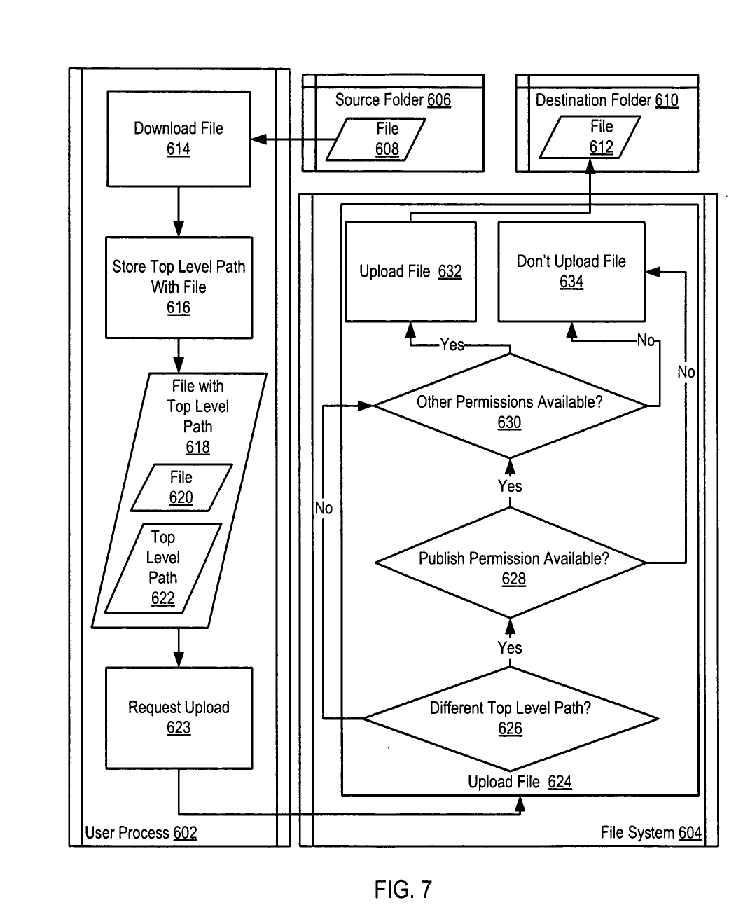

For further explanation, FIG. 7 sets forth a flow chart illustrating an exemplary method for securing computer files according to embodiments of the present invention that includes uploading a file in a file system with the publish permission attribute. The method of FIG. 7 includes attempting to upload a file that has previously been downloaded. In the method of FIG. 7, groups of users have access through a network to data stores. The method of FIG. 7 includes downloading (614) a file (608) from a source folder (606), contained in the data stores. The method of FIG. 7 also includes storing (616) the top level path (622) of the downloaded file along with the file (620), in a data structure (618).

The method of FIG. 7 also includes a user process (602) requesting (623) the file system (604) to upload the downloaded file (620). In step (626), the file system (604) determines if the top-level path of the destination folder (610) for the file (612) to be uploaded differs from the top-level path (622) for the source folder (606) of the downloaded file (608). In the method of FIG. 7, if the top-level paths are different, the file system (604) checks (628) for publish permission. If the user process (602) lacks publish permission, the file system (602) denies (634) the request (623) to upload the file. If user process (602) possesses publish permission, the file system (604) determines (630) if the user process (602) possesses other required permissions. For example, in some embodiments of the invention, write permission is required to write a file to a folder. If the other permissions are possessed, the file system (604) grants (632) the request to upload the downloaded file (620) to the destination folder (610) and the file is written to the file (612) in the destination folder (610). If the other permissions are lacking, the request (623) to upload the files is denied (634).

If the top-level path for the destination folder is the same as the top-level path of the source folder for the file that was downloaded and is now uploaded, then the file system (604) checks (630) for other permissions. The file system (604) grants (632) the upload request if the permissions are possessed and denies (634) the upload request if the permissions are not possessed.

The method of FIG. 7 is for explanation and not for limitation. In other embodiments of the invention, publish permission is granted for uploading a file only when the file is uploaded to a folder with the same top-level path as the folder from which the file was downloaded. The requirement of publish permission may be applied to the downloading and uploading in such ways as will occur to those of skill in the art, and all such alternative embodiments are well within the scope of the present invention.

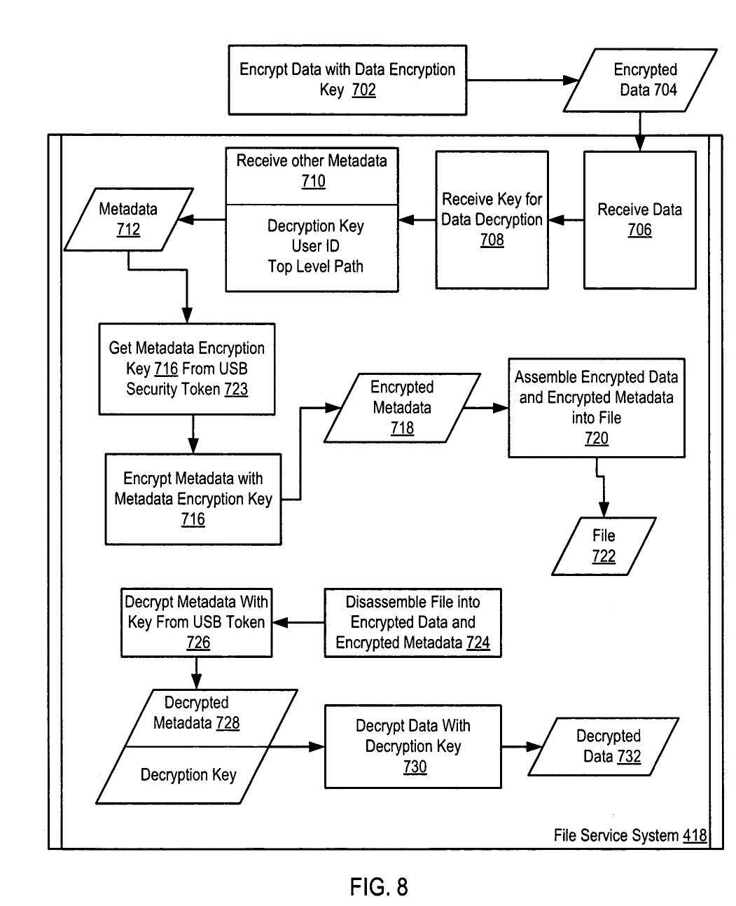

As mentioned above, if a secure file is downloaded to a local personal computer, it is preferably encrypted to maintain security. This is preferably done using a USB token and its key. For further explanation, FIG. 8 sets forth a flow chart illustrating an exemplary method for storing the key for decrypting a file. In the method of FIG. 8, a user stores an encrypted file and the key for decrypting it on a computer. The method of FIG. 8 includes encrypting (702) data (704) with an encryption key. The encryption key can be a public key obtained from a public key/private key infrastructure, a symmetric key, or any other key that may occur one of skill in the art.

The method of FIG. 8 includes receiving (706) the encrypted data (704). The encrypted data can be received, for example, by downloading it over a network or by encrypting an unencrypted file and storing the encrypted file. The method of FIG. 8 also includes receiving (708) a key for decrypting the file. In case the encryption key is a public key obtained from a public key/private key infrastructure, the decryption key can consist of the corresponding private key from the public key/private key infrastructure. When the encryption key is a symmetric key, the decryption key can consist of the same key. When the encryption key is a private key from a public key/private key infrastructure, the decryption key can consist of the corresponding public key from the public key/private key infrastructure. In case of a downloaded file, the decryption key can also be received by downloading. In case of a created file, the decryption key can be received from the same source as the encryption key.

The method of FIG. 8 includes receiving (710) other metadata (712), or data about the encrypted data. In the method of FIG. 8, the decryption key is a form of metadata. The other metadata may include the top-level path of the file that was downloaded and the user identity of the user that is storing the encrypted file on a computer. The method of FIG. 8 includes encrypting (716) the metadata (712) with an encryption key for the metadata. The method of FIG. 6 also includes assembling (720) the encrypted data (704) and encrypted metadata (718) into a file (722). Assembling the encrypted data and encrypted metadata into a file (722) can be carried out by combining them in a file (722) and inserting a header section in the file (722) which indicates the location relative to the start of the file (722) where the encrypted metadata (718) begins and the location relative to the start of the file (722) where the encrypted data (704) begins. Alternatively, assembling the encrypted data (704) and encrypted metadata (718) into a file (722) can be carried out by creating a file (722) which begins with the encrypted metadata and indicating the end of the encrypted metadata with a special symbol, such as “///”. Alternatively, assembling (720) the encrypted data (704) and encrypted metadata (718) into a file (722) can be carried out by allowing a fixed number of characters for the encrypted metadata.

The method of FIG. 8 also includes storing reading (723) the key for encrypting or decrypting the metadata in a USB security token. The value of the key, a form of data, is transmitted from the memory of the USB token to the computer over the USB bus.

The method of FIG. 8 also includes decrypting the file (722) containing the encrypted data and encrypted metadata. The file (722) is disassembled (724) into encrypted metadata and encrypted data. The encrypted metadata is decrypted (726) with a key from a USB security token. In the example of FIG. 8, the decrypted metadata includes a key for decrypting the decrypted data file, the user ID, and the top level path of the file. In the method of FIG. 8, the file service system (418) may verify that the user assigned to the USB token is the same user whose ID is contained in the metadata. If the identities do not match, then the file service system (418) halts the file decryption process. If the users do match, then the encrypted data (704) is decrypted (730) using the decryption key, producing the decrypted data (730).

In this preferred embodiment the USB token contains an encryption system and secure file storage. Thus a public key for the metadata is provided by the USB token and the related private key is stored in the USB token. The encrypted metadata is provided to the USB token and the private key is used to return the decrypted metadata.

Other variations are possible. In one variation, the USB token can merely be a USB flash drive with a secure storage area. The file system will then generate the key for encrypting and decrypting the metadata. This key is stored in the secure area of the USB flash drive.

In another variation, a smartcard and associated smartcard reader can be used instead of the USB token. In further variations, similar devices, such as parallel or serial port dongles or tokens attached to the 1394 bus can be used.

In yet a further variation, instead of conventional keys generated by the USB token, the token can be serialized and the serial number used as the key.

The method of FIG. 8 may be one of several techniques used by a file system to process computer data which is to be kept secure. The file system may utilize the method of FIG. 8, for example, to store an encrypted file downloaded from a secure folder to a local computer. Similarly, the file system may utilize the method of FIG. 8 to securely store newly generated data on a file in the local computer. In addition, the file system may require a user seeking access to secure data to log in, give a password, and to insert a USB security token containing user identification in the USB port of the local computer. The file system may also require a user process to possess publish permission in order to move secure data from one group folder to another. The file system clipboard application may also disable copying or cutting and pasting data from a secure document to any other document or application. The file system may also permit access to secure files only through a set of applications available over a network through an application server. Conversely, the file system may not utilize the method of FIG. 8 or the other techniques described above to handle data that is not to be kept secure. Such data can be stored in unencrypted form, can be accessed by a user who has not inserted a USB security token into the computer, and may be copied into other documents.

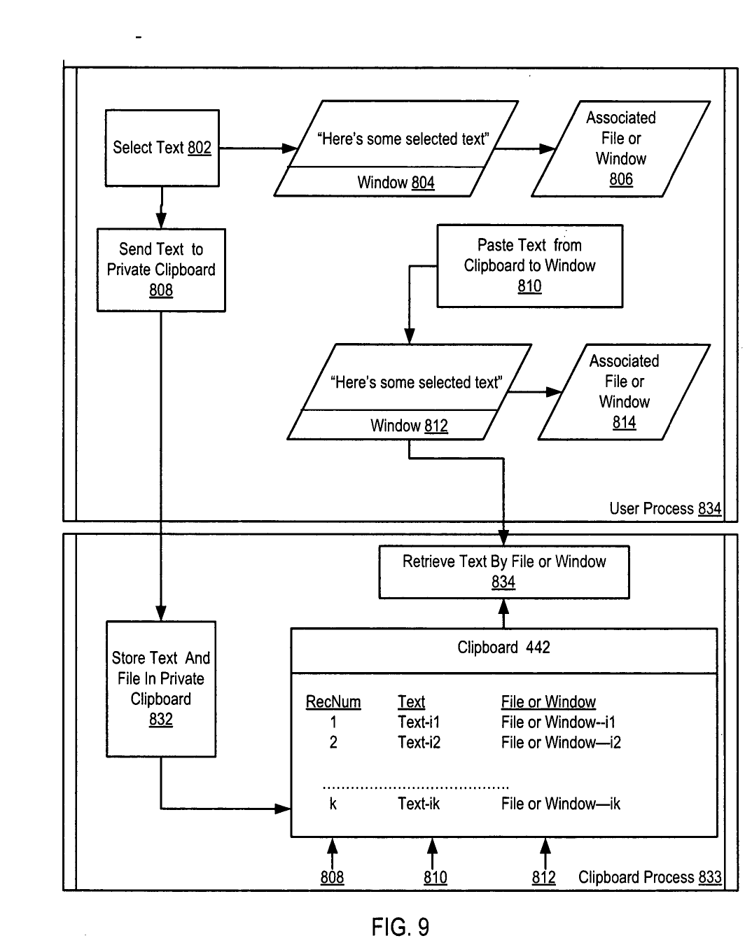

As mentioned above, security breaches may also occur when a secure file is loaded onto a relevant application, such as a word processor, and a copy to a clipboard function is used. FIG. 9 sets forth a flow chart illustrating an exemplary method for using a clipboard in which material copied to the clipboard can only be pasted into the document from which it originated. A clipboard is a function for the temporary storage and retrieval of data selected from the currently active window by a user. The method of FIG. 9 includes copying material to the clipboard. A user process (834) selects (802) text to be copied to the clipboard from a window (804) associated with a file or window (806). A window may be associated with a file, for example, by opening the file or a word processor, thereby creating a window. The user may select text by dragging a mouse on the text to be selected, by clicking at the start of the text and shift-clicking at the end of the text, by using keyboard commands to select the text, or by other methods as will occur to those of skill in the art. In the method of FIG. 9, the user selects the text “Here's some selected text” contained in window (804). The method of FIG. 9 also includes issuing a command (808) to copy the selected text to a clipboard. In the method of FIG. 9, standard keyboard commands, such as control-c (for copy) or control-x (for delete and copy to the clipboard) or standard menu commands may be used for copying the text to the clipboard.

The method of FIG. 9 also includes storing (832) the text and the identity of the file in a clipboard. In the method of FIG. 9, storing the text to the clipboard is carried out by copying the text to a non-standard clipboard which allows the pasting of material only to the document from which the material originated. This non-standard clipboard is implemented in an application by defining methods to copy material to the non-standard clipboard and retrieve material from the non-standard clipboard, by placing the definitions in the application's main windows procedure, and by tying the keyboard and menu commands for copying to the clipboard and pasting from the clipboard to these methods implementing the non-standard clipboard. In other words, the clipboard of FIG. 9 is implemented by modifying the standard definitions of clipboard methods. In this manner clipboard functionality can remain and yet will be secure.

The following pseudocode illustrates how the methods implementing the non-standard clipboard can be tied to the standard Windows menu commands. The pseudocode illustrates an exemplary implementation of the function WM_COMMAND, which defines how to process keyboard and menu commands:

```
case WM_COMMAND:
  switch (LOWORD(wParam))
  {
    case IDM_CUT:
      if (EditCopy( ))
        EditDelete( );
      break;
    case IDM_COPY:
      EditCopy( );
      break;
    case IDM_PASTE:
      EditPaste( );
      break;
    case IDM_DELETE:
      EditDelete( );
      break;
    case IDM_EXIT:
      DestroyWindow(hwnd);
  }
break;
```

This pseudocode illustrates how to process window commands. The pseudocode checks for the occurrence of a menu command, and calls the appropriate application-defined routine for executing the command. For example, in case of a copy command (IDM_COPY), this pseudocode calls the application-defined routine EditCopy( ). In case of a paste command (IDM_PASTE), this pseudocode calls the application-defined routine EditPaste( ).

In the method of FIG. 9, data copied to the clipboard (442) is associated with the file or window from which it derived. FIG. 9 contains an exemplary data structure useful in implementing clipboards according to embodiments of the present invention. In the example of FIG. 9, the clipboard (442) consists of a series of records. Each record contains the record number (836), the text or other material copied into the clipboard (838), and the file-id or window-id (840) of the file or window from which the material originated. In the method of FIG. 9, the clipboard (442) may be implemented as a queue. A record representing new material is placed on the front of the queue. When material is to be retrieved from the queue, the material is retrieved from the front. The clipboard (442) may also be implemented as an ordered data structure. The records comprising the clipboard are sorted by file-id or window-id. When a new record is added with the same file-id as an old record, the old record is deleted. The clipboard (442) can be implemented by other ways as will occur to those of skill in the art, and all such embodiments are well within the scope of the present invention.

The method of FIG. 9 also includes attempting to paste (810) material from the clipboard (442) to a window (812) associated with a file (814). In the method of FIG. 9, a user gives a command to paste text from the clipboard to a window. The command can be implemented by standard keyboard commands, such as control-v, or by menu commands. In the method of FIG. 9, the clipboard process (833) receives a paste command from a window (812) associated with a file (814). The clipboard process (833) searches the clipboard (442) for a record whose file-id or window-id (840) is that of file (814). If a record is found, the clipboard process (732) returns the text or other material (838) of the record. If a record is not found, the clipboard process (732) returns the empty string“”.

In the method of FIG. 9, the clipboard contains text or other material for multiple files and returns text or other material from a record with the same file-id as the file-id of the file or the window-id of the window in which the text or other material is to be placed. In other embodiments of the invention, the clipboard (442) may contain only material from a single file. Material newly copied to the clipboard overwrites the current material. When the clipboard (442) receives a paste request, it determines whether the material in the clipboard is from the requesting file or window. If so, the clipboard returns the material. Otherwise, the clipboard process returns the empty string“”.

In an alternate embodiment, data may be pasted from one file or window to another under conditions similar to those in which a transfer of files would be permitted. As in the example of FIG. 9, the clipboard may contain information about the file or window from which each item was copied (“source”). A request to paste an item to a file or window may contain information about the file or window to which the item is to be pasted (“target”). In such a case, the clipboard could allow the pasting operation if the user had permission to transfer data from the source to the target. A user, for example, could paste an item from one file in a group folder to another file in the same group folder. In a system similar to that illustrated in FIGS. 3 and 4, the user could paste an item from the user's private folder to any file for which the user had write permission. On the other hand, a user could not paste an item associated with a file for which the user lacked read access. In addition, the user could not paste a secure item associated with one group folder to a file or window associated with a folder for which the user lacked publish permission.

Clipboards may be implemented in a variety of ways according to how many previously copied items are currently retrievable. In alternative embodiments, a clipboard for secure data may make available for pasting only one item in total, one item for each file or window, or multiple items. In the first alternative, each time an item is copied to the clipboard, previously copied items become unavailable. In the second alternative, items in the clipboard are associated with a file or window. A new item copied to the clipboard from a file or window makes items previously copied from that file or window unavailable. In the third alternative, items copied to the clipboard accumulate. An interface to the clipboard provides access to items other than the most recently copied. The interface, for example, may show to a user all of the items which the user would be permitted to paste to the currently active window.

Clipboards may be implemented in a variety of ways according to the sharing of the clipboard among applications. In one embodiment, a clipboard may be specific to a particular application. Other applications do not have access to that application's clipboard. In other embodiments, a suite of programs from one developer may share a clipboard. The SimDesk suite of applications may, for example, share the user of a clipboard for secure files. In other embodiments, a clipboard application may be shared by unrelated developers. In such a case, the developers would have to agree on an application programming interface for placing items in the clipboard and retrieving them. They would also have to agree on standards for securing data and on a methodology for enforcing the standards. Otherwise, applications sharing the clipboard would run the risk of an unauthorized user gaining access to the clipboard through an application with lax security.

Exemplary embodiments of the present invention are described largely in the context of a fully functional computer system for securing computer files. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethemet™, and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for securing files on a computer system comprising:
classifying a first folder containing files as a secure folder with a selected security setting;
receiving a request from a user to write a first file in said first folder to a second folder having a different security setting than said first folder;
determining if the user has a publish permission to write said first file to said second folder;
if publish permission is present, writing said first file to said second folder; and
if publish permission is not present, denying the request to write said first file.

2. The method of claim 1, wherein the security settings for said first and second folders are based on the users present in a group assigned to each folder, and
wherein the users present in the group for said first folder and the group for said second folder are different.

3. The method of claim 1, further comprising:
receiving a request from a user to write said first file to a third folder having the same security setting as said first folder; and
writing said first file to said third folder.

4. The method of claim 1, wherein the security setting for said first folder is based on the users present in a group assigned to said first folder, and further comprising:
receiving a request from the user to write said first file to a third folder accessible only by the user; and
writing said first file to said third folder.

5. The method of claim 4, wherein writing said first file to said third folder is performed only if the user has publish permission.

6. The method of claim 4, further comprising:
receiving a request from the user to write said first file copy from said third folder to said second folder;
determining if the user has publish permission to write said first file copy to said second folder;
if publish permission is present, writing said first file copy to said second folder; and
if publish permission is not present, denying the request to write said first file copy.

7. The method of claim 4, wherein said first folder is present on a shared storage element and said third folder is present on a local computer.

8. The method of claim 4, wherein said first folder and said third folder are present on a shared storage element.

9. A computer-readable medium or media having computer-executable instructions for performing the method recited in any one of claims 1-8.

10. A computer system for securing computer files, the system comprising:
a processor unit;
a memory operatively coupled to the processor unit; and
an application executable within the processor unit and memory, the application capable of performing the method recited in any of claims 1-8.
